(19) United States
(12) Patent Application Publication
(10) Pub. No.: US 2023/0392986 A1
(43) Pub. Date: Dec. 7, 2023

(54) NONLINEARITY CORRECTION AND RANGE FITTING FOR STEREOSCOPY THROUGH ILLUMINATION AND APPROACHES TO USING THE SAME FOR NONCONTACT COLOR DETERMINATION

(71) Applicant: Ringo AI, Inc., Santa Cruz, CA (US)

(72) Inventors: Dan Allen, Springville, UT (US); Jyoti Kiron Bhardwaj, Cupertino, CA (US)

(21) Appl. No.: 18/362,877

(22) Filed: Jul. 31, 2023

Related U.S. Application Data
(63) Continuation of application No. PCT/US2022/070485, filed on Feb. 2, 2022.
(60) Provisional application No. 63/144,756, filed on Feb. 2, 2021.
(60) Provisional application No. 63/212,171, filed on Jun. 18, 2021.

(51) Int. Cl. G01J 3/51; G01J 3/28; G01J 3/10

(52) U.S. Cl. CPC G01J 3/51; G01J 3/2823; G01J 3/10

(57) ABSTRACT

Introduced here are computer programs and associated computer-implemented techniques for determining range of an object using a single camera. Specifically, an approach to utilizing a computing device to capture range-related information from an object (also called a “target”) using illumination parallax and spectral analysis of corresponding images is disclosed herein. To achieve illumination parallax, a series of illumination events may be performed in sequence, such that the target is sequentially illuminated with different ranges of electromagnetic radiation. Information regarding the target can be computed, inferred, or otherwise determined through analysis of images captured in conjunction with the illumination events.

### CROSS-REFERENCE TO RELATED APPLICATIONS

This application is a continuation of International Application No. PCT/US2022/070485, filed on Feb. 2, 2022, which claims priority to U.S. Provisional Application No. 63/144,756, filed on Feb. 2, 2021, and U.S. Provisional Application No. 63/212,171, filed on Jun. 18, 2021, each of which is incorporated by reference herein in its entirety.

### TECHNICAL FIELD

Various embodiments concern multispectral imaging of three-dimensional objects.

### BACKGROUND

Accurately determining the color and share of objects is an important aspect of capturing digital images (or simply “images”) of three-dimensional objects. This is especially true for images with health applications, cosmetic applications, manufacturing applications, and commerce applications—especially electronic commerce (also called “e-commerce”) applications where the actual objects may not be readily viewable to consumers.

Historically, color and shade have been estimated by putting a spectral sensing instrument (also called a “spectral sensing tool”) in close proximity to an object of interest, blocking ambient light from hitting the object, and then providing a well-characterized illumination at a fixed distance. FIG. 1 illustrates how a spectral sensing instrument 100 may include an illuminant 102 for emitting the well-characterized illumination and a sensor 104 for detecting the reflection of the well-characterized illumination off the object. One example of a sensor 104 is a photodetector (or simply “detector”). As shown in FIG. 1, a shroud 106 may be used to block the ambient light, as well as off-axis illumination to direct specular reflections away from the sensor 104.

Contactless spectroscopy (also called “noncontact spectroscopy”) is more difficult since the intensity received by the sensor strongly correlates with the distance between the sensor and object of interest. Special imaging over the surface of a non-flat object is even more difficult due to the complexities of how light affects color and shade. For example, surfaces that are tilted away from the illuminant will appear darker due to the incident light projecting across a larger area. Accordingly, accurately determining color and shade of an object requires knowledge of the shape and range of the object.

With machine learning algorithms, it is possible to estimate the shape of an object from a two-dimensional image. At a high level, these machine learning algorithms attempt to extrapolate information regarding the object, including its shape, based on pixel-level analysis of the two-dimensional image. Classification-based approaches for three-dimensional shapes optimize more readily for particular genres of target, such as human faces or vehicles. However, even if the shape of an object is known, the distance to the object (e.g., as measured from the sensor used to generate the image) will still have a range of uncertainty. For example, a small object that is relatively close may be visually similar to a larger object that is further away, and images of the small and large objects may be largely indistinguishable from one another.

One reason that range is important for noncontact spectroscopy is that color can be determined from the shape of the spectral response. For example, while pink, red, and burgundy may share the same reflectivity spectral shape, the magnitude of the reflection will determine whether the color appears light or dark. Accordingly different magnitudes of reflection can result in different shades.

To estimate the shade of an object, an individual typically provides a known spectrum of light and then measures the reflection returned by the object using a sensor, attributing the relative brightness to the object's limited reflectivity. For sources of light with small angular subtense relative to the object and sensor, the amount of light that is returned from an illumination event (also called a “flash event” or simply “flash”) reduces with the fourth power of distance. These sources of light may be called “point sources” of illumination. Accordingly, doubling the distance will result in roughly sixteen times less light. For this reason, accurately determining range—particularly at close distances—is critical to accurately determining shade.

### BRIEF DESCRIPTION OF THE DRAWINGS

FIG. 1 illustrates how a spectral sensing instrument may include an illuminant for emitting the well-characterized illumination and a sensor for detecting the reflection of the well-characterized illumination off the object.

FIG. 2A illustrates the geometric relationships between an image sensor, a first illuminant, and a second illuminant of a computing device with respect to a target.

FIG. 2B includes a diagrammatic illustration of a computing device with multiple illuminants.

FIG. 3 illustrates how different regions of a display could be used as illuminants.

FIG. 4 includes a diagrammatic illustration of a laser that is illuminating a target that resides within the field of view of an image sensor.

FIG. 5 includes a diagrammatic illustration of an illuminant, such as a light-emitting diode (LED), that is illuminating a target that resides within the field of view of an image sensor.

FIG. 6A depicts a top view of a multi-channel light source that includes multiple color channels able to produce different colors.

FIG. 6B depicts a side view of the light source illustrating how, in some embodiments, the illuminants reside within a housing.

FIG. 6C depicts a computing device that includes a rear-facing camera and a multi-channel light source that is able to illuminate the ambient environment.

FIG. 7A shows an example of an array that includes eight dies associated with five different color channels.

FIG. 7B shows an example of an array that includes three dies associated with three different color channels.

FIG. 8 depicts an example of a separation mechanism arranged over an image sensor.

FIG. 9 depicts an example of a communication environment that includes a characterization module programmed to controllably illuminate a target and then examine images of the target to determine color and shade.

FIG. 10 illustrates a network environment that includes a characterization module.

FIG. 11 includes a flow diagram of a process for determining an estimated range to a target from a computing device that includes (i) first and second illuminants, spaced apart with different wavelengths and (ii) an image sensor with spectral filtering subpixels.

FIG. 12 includes a flow diagram of a process for estimating the in situ pixel-by-pixel nonlinearity via illumination of a target with multiple illuminants with distinct modulation frequencies, based on measurements of the intermodulation distortion.

FIG. 13 includes a flow diagram of a process for obtaining pixel spectra for images generated by a computing device.

FIG. 14 is a block diagram illustrating an example of a processing system in which at least some operations described herein can be implemented.

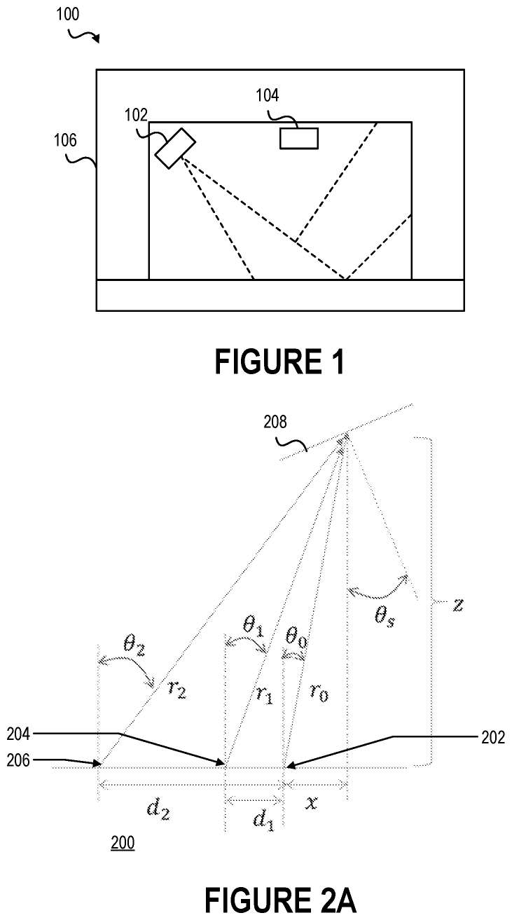

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Conventional approaches to determining range normally rely on time of flight, structured light, or stereoscopy. Each of these conventional approaches requires dedicated hardware, however. For example, conventional approaches that rely on time of flight or structured light require specialized sensors, while conventional approaches that rely on stereoscopy require multiple cameras to achieve depth by means of stereopsis. While these cameras may not be specialized, computing devices with two imaging pipelines that are capable of collecting and processing images simultaneously are more complicated than computing devices with a single camera or a single imaging pipeline.

Given the space constraints of modern computing devices, especially those designed for portability like mobile phones, it is desirable to limit the amount of dedicated or specialized hardware that is needed. This design constraint applies to the components needed for imaging too, and therefore will affect the ability of a computing device to determine range and related parameters like shade.

Introduced here, therefore, are computer programs and associated computer-implemented techniques for determining range of an object using a single camera. Specifically, an approach to utilizing a computing device to capture range-related information from an object (also called a “target”) using illumination parallax and spectral analysis of corresponding images is disclosed herein. To achieve illumination parallax, a light source may rapidly perform a series of illumination events in sequence, such that the target is sequentially illuminated with different ranges of electromagnetic radiation. Note that the term “illumination event” may be used interchangeably with the terms “flash event” and “flash.”

As further discussed below, the light source may have multiple channels, each of which may include one or more illuminants that are able to produce visible light or non-visible light. For example, the light source may include at least two channels, and each channel may include one or more light-emitting diodes (LEDs) that are able to produce light of a different color. In other embodiments, the light source further includes at least one channel with illuminants capable of emitting electromagnetic radiation in a non-visible range, such as the ultraviolet range or infrared range. A multi-channel light source (also called a “multi-channel emitter”) can achieve multi-angle illumination of the target using different colors. As the multi-channel light source performs the series of flashes, the camera may produce a corresponding series of images. Each image in the series of images may be associated with a corresponding flash in the series of flashes.

A machine learning algorithm can then be applied to the series of images, so as to compute, infer, or otherwise determine not only the shape of the target but also its range. Other characteristics could also be computed, inferred, or otherwise determined by the machine learning algorithm. Examples of such characteristics include the absolute amount of light striking the target, the distribution of color and share across the surface of the target, and the like.

The approach described herein can address practical problems related to the use of cameras and illuminants in determining range in real applications. Notably, the approach allows for determination of, and compensation for, nonlinearity of the camera (and, more specifically, its image sensor) that acts as a receiver. This is important when demodulating or decoding in the presence of multiple signals. Note that the approach can work without perfect synchronization of the multi-channel light source and camera. The approach may utilize a domain transformation in order to identify a pattern, as opposed to true synchronization.

For the purpose of illustration, embodiments may be described in the context of particular types, colors, or arrangements of illuminants. For example, the technology may be described in the context of a computing device that includes multiple single-channel light sources, a multi-channel light source and one or more single-channel light sources, or multiple multi-channel light sources. Those skilled in the art will recognize that the features of a given embodiment may be similarly applicable to other embodiments unless otherwise specified.

Embodiments may also be described with reference to “illumination events,” “flash events,” or “flashes.” Generally, illumination events are performed by a computing device to flood an ambient environment with visible light for a short interval of time while an image of the ambient environment is captured. While embodiments may be described in the context of capturing still images in conjunction with illumination events, those skilled in the art will recognize that the features are similarly applicable to capturing a series of frames that are representative of a video.

While aspects of the present disclosure generally concern the design and construction of an illuminating and imaging system (or simply “system”) of a computing device, several of the concepts described below concern the control of the system (e.g., in terms of how it drives its illuminants) and analysis of images output by the system. For simplicity, these concepts may be described in the context of executable instructions for the purpose of illustration. However, those skilled in the art will recognize that aspects of these concepts could be implemented via hardware, firmware, or software. As an example, a computer program that is representative of a software-implemented characterization module (or simply “characterization module”) designed to facilitate image capture and analysis may be executed by the processor of a computing device. This computer program may interface, directly or indirectly, with hardware, firmware, or other software implemented on the computing device.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

The term “based on” is to be construed in an inclusive sense rather than an exclusive sense. That is, in the sense of “including but not limited to.” Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Differential Illumination Parallax

At a high level, the approach described herein relies on using illumination from different directions to determine range. However, this also requires knowledge of certain information regarding the target. It is to be expected from geometry that the amount of light that strikes a target will decrease as the cosine of the angle from normal decreases. Thus, illuminating the target from different directions will provide a differential in brightness that is affected by the range. The differential should decrease the greater the distance between the light source and target.

This differential will also depend on the angle of the target with respect to the flash normal, the angle of the target with respect to the image sensor of the camera, the tilt of the target, and the angle-dependent scattering of light between the light source and target. If all of these factors are unknown, then there may not be enough information to accurately determine distance to the target. In order to employ the approach described herein, the number unknown factors should ideally be reduced.

Some classes of target have approximately angle-independent scattering, such that the incoming light (also called the “incident light”) is scattered in a way that the same amount of energy is detected regardless of the detection of the detector. This type of scattering is called “Lambertian scattering.” With Lambertian scattering, incident light is scattered off the target equally in all directions. With respect to the surface of the target, the scattered light falls off as the projected width of the target, giving the scattering a cosine dependence. From a direct perspective (also called the “face-on perspective”), illumination is maximal. From an “edge-on” perspective, there may be no projected width, so the illumination will go to zero. This same geometric effect may apply to planar components like illuminants (e.g., LEDs) and the image sensor of the camera.

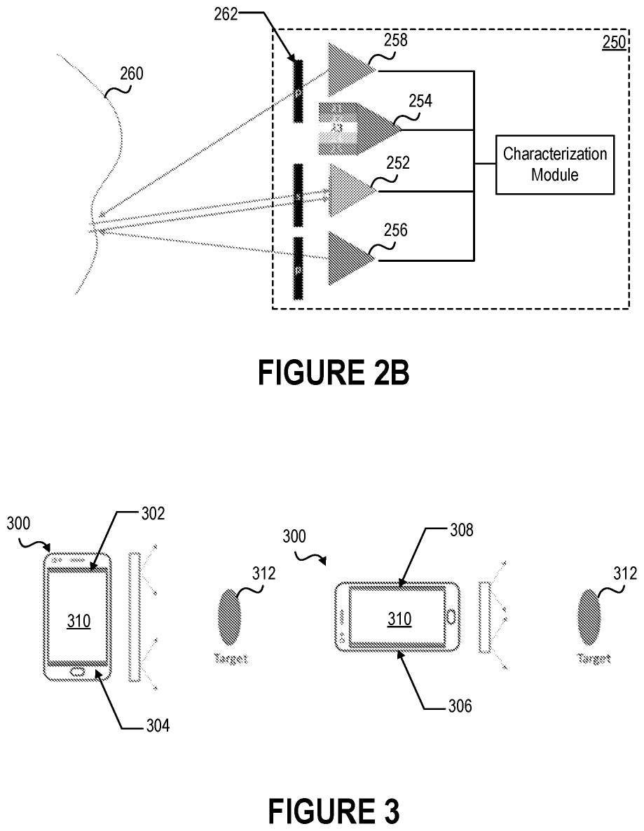

FIG. 2A illustrates the geometric relationships between an image sensor 202, a first illuminant 204, and a second illuminant 206 of a computing device 200 with respect to a target 208. Examples of image sensors include charge-coupled device (CCD) sensors and complementary metal-oxide semiconductor (CMOS) sensors. In FIG. 2A, x represents the lateral distance between the image sensor 202 and target 208; z represents the longitudinal distance between the image sensor 202 and target 208; d₁ represents the lateral distance between the image sensor 202 and first illuminant 204; d₂ represents the lateral distance between the image sensor 202 and second illuminant 206; r₀ represents the range from the image sensor 202 to the target 208; r₁ represents the range from the first illuminant 204 to the target 208; and r₂ represents the range from the second illuminant 206 to the target 208. Respective angles from normal are similarly labeled as θ₀, θ₁, and θ₂ for the image sensor 202, first illuminant 204, and second illuminant 206. Note that the following disclosure can be generalized to any “n” number of illuminants, where “n” is an integer value larger than one.

Assuming that (i) each illuminant is roughly representative of a point source, (ii) there is Lambertian emission from the i'th illuminant, (iii) there is Lambertian reflection from the surface of the target 208, and (iv) there is Lambertian response from the image sensor 202, the intensity per area (A) of the target 208 at the image sensor 202 can be expressed as follows:

$$\frac{{dI}_{i}}{dA} = \int d λ I ( λ ) R ( λ ) \frac{( cos {θ}_{i} cos ( {θ}_{i} + {θ}_{s} ) )}{{r}_{i}^{2}} \frac{( cos ( {θ}_{s} + {θ}_{0} ) cos {ϑ}_{0} )}{{r}_{0}^{2}} . \qquad Eq . 1$$

The illuminant emits according to a wavelength-dependent spectral function I(λ) and the target has a wavelength-dependent reflectivity R(λ). Using the additive identity for cosines and definitions of sine and cosine, the angle- and range-dependent portions can be expressed in terms of the experiment dimensions, namely as:

$$\frac{{z}^{2}}{{r}_{i}^{2} {r}_{0}^{2}} [ ( {d}_{i} + x ) x + ( {z}^{2} - ( {d}_{i} + x ) x ) {cos}^{2} {θ}_{s} - z cos {θ}_{s} sin {θ}_{s} ( {d}_{i} + 2 x ) ] . \qquad Eq . 2$$

There is a position of symmetry for a given angle of the target 208 where the differential between return intensity the first illuminant 204 and second illuminant 206 is minimal. However, if the shape of the target 208 is known, regions of the target 208 for which the differential is null can be used for range determination.

Alternatively, if there is a sufficient variety of illuminants, illuminants with positions that do not create a null in the differential can be selected. As an example, this may be the case if the illuminants are part of a light source in display form, where different regions could be operated as independent illuminants. FIG. 3 illustrates how different regions of a display could be used as illuminants. In FIG. 3, for example, the “illuminants” are represented using the top edge 302, bottom edge 304, left edge 306, and right edge 308 of a display 310 of a computing device 300, depending on whether the computing device 300 is in the portrait or landscape orientation. By separately driving these “illuminants,” the computing device 300 can illuminate the target 312 from different spatial positions. Those skilled in the art will recognize that the “illuminants” could be defined otherwise, for example, using corners of the display or defining each quadrant as a separate “illuminant.”

To see the general behavior of Eq. 2, assume that the first illuminant 204 is located in approximately the same spatial position as the image sensor 202, such that d₁ equals zero and d₂ equals d. Further, let the angle of the target surface be zero (i.e., θₛ=0). In this scenario, r₁ equals r₀T and the differential return intensity for the first illuminant 204 simplifies to:

$$\frac{{dI}_{1}}{dA} = \frac{{z}^{4}}{{r}_{0}^{4}} . \qquad Eq . 3$$

For the second illuminant 206, the differential return intensity simplifies to:

$$\frac{{dI}_{2}}{dA} = \frac{{z}^{4}}{{r}_{2}^{2} {r}_{0}^{2}} . \qquad Eq . 4$$

The relative difference between the differential return intensities can then be expressed as:

$$\frac{{dI}_{1} - {dI}_{2}}{{dI}_{1}} = 1 - \frac{{r}_{0}^{2}}{{r}_{2}^{2}} = 1 - \frac{{x}^{2} + {z}^{2}}{{( d + x )}^{2} + {z}^{2}} . \qquad Eq . 5$$

By checking the limits, one can see that (i) the difference goes to zero as separation d between the illuminants goes to zero and (ii) the difference grows (i.e., the second term shrinks) as separation d between the illuminants increases. The differential resolution also improves with increasing lateral distance between the image sensor 202 and target 208 (i.e., with increasing x) and goes to zero when x equals −d/2. This value corresponds to the aforementioned scenario where there is no differential intensity due to symmetry.

FIG. 2B includes a diagrammatic illustration of a computing device 250 with multiple illuminants. As discussed above, this array could be used to determine range via differential reflectance. The computing device 250 can include an image sensor 252 and various illuminants. In FIG. 2B, for example, the computing device 250 includes a multi-channel light source 254 that is able to emit light of different colors, a single-channel light source 256 that is able to emit light of a first color (e.g., red), and another single-channel light source 258 that is able to emit light of a second color (e.g., blue).

As shown in FIG. 2B, the multi-channel light source 254 and single-channel light sources 256, 258 can be spaced apart from one another. For example, the spacing between these light sources may be at least 3 millimeters, 5 millimeters, or 10 millimeters. The distance between the multi-channel light source 254 and single-channel light source 256 may be different than the distance between the multi-channel light source 254 and single-channel light source 258.

As further discussed below, light can be controllably emitted towards a target 260 by the multi-channel light source 254 and single-channel light sources 256, 258. For example, the multi-channel light source 254 may initially emit red and blue light towards the target 260, and the image sensor 252 can record a first image based on light reflected by the target 260. Then, the multi-channel light source 254 may emit red light towards the target 260 while the single-channel light source 256 emits blue light towards the target 260, and the image sensor 252 can record a second image based on light reflected by the target 260. Additionally or alternatively, the multi-channel light source 254 may emit blue light towards the target 260 while the single-channel light source 258 emits red light towards the target 260, and the image sensor 252 can record a third image based on light reflected by the target 260. In some embodiments, the single-channel light source 256 may emit blue light towards the target 260 while the single-channel light source 258 emits red light toward the target 260, and the image sensor can record a fourth image based on light reflected by the target 260. The range between the image sensor 252 and target 260 could be determined based on an analysis of the first image, second image, third image, fourth image, or any combination thereof.

As shown in FIG. 2B, polarizers 262 may be situated over the image sensor 252, multi-channel light source 254, or single-channel light sources 256, 258 in an attempt to reduce specular scatter. At a high level, these polarizers 262 may help “tune” or “target” those components to more narrowly tailored electromagnetic ranges.

There are several matters of practical concern, and these matters are discussed in greater detail below. These matters include the following:
Limited image sensor performance, particularly signal-to-noise ratio (SNR) and linearity;
Ambient light interference;
Single exposure versus multi-exposure and associated motion sensitivity;
Assumption that the target will experience Lambertian scattering; and
Emission stability of the illuminants over different currents and temperatures.

### A. Limited Image Sensor Performance

Limited performance of the image sensor can be a concern due to the small difference between the intensity of illuminants spaced near one another relative to the distance to the target (e.g., where intra-illuminant distance is less than 5, 2.5, or 1 percent of the target distance). In a modern image sensor with pixel pitch of several microns, a limiting noise source is shot noise. Where there are a maximum “n” number of electrons in the well of the image sensor, the fundamental noise limit is \sqrt{n} and the resulting maximum SNR is

$$\frac{n}{\sqrt{n}} = \sqrt{n} .$$

Assume, for example, that a computing device includes a relatively high-performance image sensor with SNR=250 (with >62,500 electron well capacity). In this scenario, the minimum resolvable difference in illumination is 1/250 or 0.4 percent. With a target distance of 50 centimeters (cm) and intra-illuminant separation of 1 cm, the differential intensities will range from 0 to 0.8 percent depending on where target lateral offset x falls within the range of −0.5 cm to 10 cm. With a range of 100 cm, the differential intensity will drop by roughly four times to 0.2 percent. The resulting range resolution can be estimated using a linear approximation as the change in intensity difference divided by the change in distance. Calculating expected sensitivity values in the range of 0 to 0.012 percent per cm with x in the range of −0.5 cm to 10 cm has shown that pixel performance is generally insufficient to resolve the difference.

However, this consideration is not for a single pixel. Instead, each image that is generated by the image sensor may have more than a million pixels, depending on the resolution. Assuming that (i) the noise is large compared to the parameter to be measured and (ii) the resolution is less than the noise—which is normally valid for 10-12 bit image sensors—then a group-constrained fit can be performed.

As further discussed below, the shape of the target may be estimated based on an output produced by a machine learning algorithm that is applied to an image of the target or a three-dimensional rendering created from a mosaic of images of the target. Based on this estimated shape, the expected difference in intensity can be estimated at each position along the surface of the target at that distance. Then, the distance estimate can be adjusted so that the expected differential intensity can be calculated repeatedly, until a minimum error between the prediction and measurement differential intensities can be found. For example, the distance may be adjusted in an effort to minimize the total number or magnitude of errors between calculated and measurement using any suitable matrix pseudo-inverse method, resulting in an optimized estimate of the target position. In essence, this is similar to averaging all available pixels that may be on the order of hundreds of thousands or millions. SNR tends to improve as the square root of the number of pixels averaged, so for 100,000 pixels, the range estimate is expected to improve by a factor of roughly 300. However, it is important to note that there will be noise added if the images from different illuminants are taken separately. Ideally, the improvement in range resolution from ensemble estimation should put the accuracy in the range relevant for accurate shade estimation.

Although the intensity difference drops off as the square of the distance to the target, the return intensity curve is to the fourth power as mentioned above. So as that curve flattens at longer distances, accuracy in estimating shade will improve. While the differential intensity is lower at longer distances, the sensitivity of shade to distance drops even faster. This continues until the return intensity drops to the level where signal intensity limits the SNR.

Accordingly, a method for using a camera with an image sensor housed therein for estimating range indicates using as many pixels as possible—or as practical given constraints in time or computational resources—can help lessen the error between the expected and measured intensity differentials.

### B. Linearity

Linearity of the image sensor is also important to the accuracy of the range fit, so the image sensor should be well characterized with nonlinear compensation, or else the image sensor should be used only in its linear range. This may place some nonideal requirements on the computing device that is responsible for implementing the approach described herein. Linearity can not only vary from pixel to pixel, but linearity can experience temporal and temperature variations. Moreover, nonlinearity is generally modeled as a function of the pixel direct current (DC) level, so it may need to be compensated pixel by pixel for each image.

The modulation signal intensities detected by the image sensor should be significant compared to the background or ambient light, and the pixel wells should be as full as possible to maximize the SNR. Generally, useful SNR—namely, where the noise is representative of fluctuation in the background—requires that the signal be at least 10 times, and preferably at least 100 times or 1,000 times, the noise. Accordingly, it may be preferable to use the upper end of the pixel response curve for range and SNR reasons. But this is where nonlinearity is typically significant—often by design—to improve dynamic range.

A typical pixel response curve exhibits a saturation curve that can be approximated with a Taylor series having primarily odd order response, as follows:

R(x)˜a₁x+a₃x³+a₅x⁵+ . . . Eq. 6

For typical saturation-type pixel responses, the third-order term is negative—leading to a “roll over” or droop in the pixel response for larger signals. For example, if the input intensity is increased by ten percent, the pixel response will increase by less than ten percent.

One way to characterize linearity is to compute a series of measurements at various known intensities with enough data points to determine an appropriate fit. This isn't always practical because the computation may not only take several seconds—leading to delay—but may also result in a poor user experience. Additionally, the target may move or the ambient lighting conditions may change as the computation occurs, resulting in inaccurate measurements.

Accordingly, an approach to performing nonlinearity correction is disclosed herein. In the approach, nonlinearity is detected in the frequency domain and then corrected through the use of at least two modulated illuminants. This concept is roughly analogous to how a diode can be used to demodulate a signal by mixing multiple frequencies. The amplitude of a demodulated signal indicates how nonlinear that pixel is. Assume, for example, that a first illuminant and second illuminant are modulated at distinct frequencies ω₁ and ω₂. For periodically modulated illumination, the pixel nonlinearity can lead to sum and difference frequency generation. With a sampling rate (also called a “frame rate”) that is lower than any signal modulation, the primary difference frequencies can be detected.

The third-order term may have different frequency terms that are proportional to cos(2ω₁−ω₂) and cos(ω₁−2ω₂). Distinct modulation frequencies ωᵢ other than the sample rate ωₛ (also called the “frame rate”) can be obtained aliasing at ωₛ−ωᵢ. For ω₁>ω₁, the third-order term can be detected at 2ω₁−ω₂. A fifth-order term can also be obtained at that frequency, and an additional fifth-order term can be obtained at 3ω₁−2ω₂.

By recording a series of images and then analyzing the corresponding temporal series of values for each pixel, the amplitudes of the two different frequencies can be detected. There are two unknown nonlinearity coefficients that can be solved for, but the signal amplitudes should be determined first. The signal amplitudes at each pixel can be estimated from the signal at either the respective modulation frequency amplitude or alias if it is faster than the sample rate. The signal amplitudes at the respective frequencies can be determined by a discrete Fourier transform, fast Fourier transform, wavelet transform, and the like.

As an example, if 2ω₁ is set to equal ω₂, then the third-order term will be zero. It can then be assumed that the dominant response is from the fifth-order term from modulation at 3ω₁−2ω₂. Then, the frequency can be changed to find the coefficient a₃ of the third-order term from modulation at 3ω₁−2ω₂, either by nulling the fifth-order term or by subtracting it based on the measured coefficient, with errors at the seventh- and higher-order terms due to the truncation of the series. Accordingly, pixels may be ignored if those pixels are so far along their nonlinearity that higher-order terms are not negligible. This can be established based on the general shape of the pixel response as indicated in the image sensor datasheet, for example, or a rule that is based on the size of the pixel response relative to the size of the third- or fifth-order term.

These simplifications make this approach useful for characterizing pixel nonlinearity in situ, as it can be accomplished before three-dimensional or spectral measurements, after three-dimensional or spectral measurements, or periodically as indicated or necessary for the desired accuracy. For pixels that do not receive sufficient light, a nominal nonlinearity correction may be assumed. Alternatively, a previous nonlinearity correction may be carried over, or a temperature-parameterized version of the nonlinearity correction may be computed. Nonlinearity correction can then be accomplished by either modulating a single light source at two or more frequencies or modifying two or more light sources at independent frequencies.

Assuming that the pixel response is monotonic, there will be a one-to-one mapping between the measured pixel response and input. For future measurements, nonlinearity can be corrected by converting each saturated pixel measurement into a pixel signal that is linear, prior to performing any demodulation. Such an approach ensures that the nonlinearity does not contribute to spurious frequencies. This will be important when many signals are multiplexed together in the frequency domain. In the following sections, it is assumed that the either the image sensor is linear or the data its creates is “linearized.”

### C. Ambient Light Exposure

A multi-angle illumination scheme requires that the target be exposed to light emitted from different directions. Generally, the illuminants responsible for emitting the light are quite close, however, so small changes in illumination need to be measured. Each exposure of the image sensor that results in an image will capture light from the corresponding flash in addition to ambient light from uncontrolled sources, such as sunlight or fixtures (e.g., lamps) in the ambient environment. A small change in the ambient light between exposures can overwhelm the difference that is expected given a small change in illumination angle. Exemplary equations for a first measured intensity and second measured intensity are provided below:

Iₘₑₐₛ_{₁}=I_{flash}_{₁}+I_{ambient}_{₁}; and Eq. 7

Iₘₑₐₛ_{₂}=I_{flash}_{₂}+I_{ambient}_{₂}. Eq. 8

The difference between the first measured intensity and second measured intensity can then be computed. The difference between the light returned from the flash should be much larger (e.g., at least 10, 100, or 1,000 times) than the difference in the ambient background between the first measured intensity and second measured intensity.

Using a brighter flash, decreasing the distance to the target, and shortening the exposure can help to mitigate the impact of variants in the ambient light. While a characterization module executing on a computing device may instruct the computing device (and, more specifically, its operating system) to use a brighter flash or shorten the exposure, there may not be a practical way to decrease the distance to the target without requesting that a user of the computing device do so. Generating at least one image with flash and at least one image without flash, such that the ambient light can be characterized through comparison of those images and then subtracted accordingly, can be helpful. However, this process can take several hundredths of a second, which may exacerbate motion artifacts, and can restrict throughput. Said another way, this process may have a limited bandwidth in comparison to the readout speed of the image sensor for cancelling the alternating current (AC) component of light emitted by a pulse-width modulated LED or flicker at the power frequency of a mains AC line.

In some embodiments, the computing device includes a light source with multiple channels, namely, a first channel with a first illuminant and a second channel with a second illuminant. The first and second illuminants may be able to emit electromagnetic radiation of different wavelengths. The first illuminant may be one of multiple illuminants in the first channel, and the second illuminant may be one or multiple illuminants in the second channel. In other embodiments, the computing device includes first and second illuminants—each of which is representative of a discrete light source—rather than a single multi-channel light source, though the first and second illuminants may still emit electromagnetic radiation of different wavelengths. Moreover, the computing device can include an image sensor that has multiple colored or wavelength-selective pixels. One example of such an image sensor is one with a Bayer filter mosaic or another color filter array (CFA) for arranging red-green-blue (RGB) filters on each pixel, so as to create colored subpixels.

One method of using the computing device involves shining the first and second illuminants at the same time, relying on the spectral discrimination provided by the colored subpixels to differentiate the illuminants. Some spectral “crosstalk” is expected. For example, a blue subpixel may pick up some red light, and a red subpixel may pick up some blue light. When the first and second illuminants produce similar return light intensity, crosstalk less than an order of magnitude is generally manageable. To further reduce spectral overlap, one or more additional spectral channels—each with one or more illuminants—can be used in a spectral transform (e.g., as a linear combination) to synthesize more orthogonal colors. Those skilled in the art will recognize that these additional spectral channels could be included in the multi-channel light source or separate light sources. This addition of spectral channels is conceptually similar to a concept that is commonly called “white balancing,” but here the goal is not accurate color representation but less overlap of spectral profiles.

One challenge with this illumination scheme is that if the color of the target is unknown, the expected ratio of return intensity of the two different wavelengths will not be known. If the first and second illuminants were the same color, the result would be the same return intensity from slightly different illumination angle, less angle dependence. However, since the first and second illuminants are different colors, the expected ratio is initially unknown.

In some embodiments, the computing device includes a multi-color first illuminant. For example, the first illuminant may include a first LED able to emit light of a first color (e.g., blue) and a second LED able to emit light of a second color (e.g., red). In some embodiments, the first illuminant has more than two channels. Thus, the first illuminant could also include a third LED able to emit light of a third color (e.g., green), a fourth LED able to emit light of a fourth color (e.g., amber), etc. In some embodiments, the first illuminant includes at least one LED that is able to emit non-visible light (e.g., ultraviolet or infrared light).

In a method of use, the computing device may record an image exposure with the first illuminant, with the first and second colors on. Said another way, the computing device may record an image exposure with the first illuminant with its color channels on. The image sensor may have corresponding color discrimination subpixels. Accordingly, the image can be used to estimate the expected ratio of the first and second colors. With this information, a characterization module executing on the computing device can determine the color of the target.

If the second illuminant spaced apart from the first illuminant is red, then a second exposure may use the blue LED in the first illuminant and the more distant red LED of the second illuminant. The return light from the red channel should be less if it is at a higher angle of incidence to the surface of the target. With the information that can be gleaned through analysis of an image recorded in conjunction with the second exposure, the characterization module can estimate the angle-dependent change relative to the expected ratio.

Again, pixel performance may be a limiting factor. Each pixel samples a different point along the surface of the target, which may be a unique color and shade. As such, the estimate of the actual color of the target, or rather the expected ratio, will have a degree of uncertainty. To address this, the characterization module can look for the average difference relative to the expected or normalized difference relative to expected over many pixels (e.g., thousands, tens of thousands, or hundreds of thousands) in order to achieve the requisite SNR.

This approach has the advantage of being able to capture both illuminants in the same exposure. It limits the possible influence of 1/f noise from the image sensor on the differential signal. However, ambient light will generate a baseline signal.

Referring again to the example above in which the first illuminant includes red and blue LEDs, for the first exposure, using the red and blue LEDs from the first illuminant will result in two measured intensities, namely:

I_{pre 1b}=I_{flash 1b}+I_{ambient pre b}; and Eq. 9

I_{pre 1r}=I_{flash 1r}+I_{ambient pre r}. Eq. 10

In the second exposure, there is red light from the second illuminant and blue light from the first illuminant, as follows:

I_{meas 2r}=I_{flash 2r}+I_{ambient meas r}; and Eq. 11

I_{meas 1b}=I_{flash 1b}+I_{ambient meas b}. Eq. 12

Before comparing the measured intensities with the presampled (i.e., expected) intensities, the characterization module may first account for differences in ambient light intensity. Here, an assumption may be made that color of the ambient light has not changed, only its intensity. This allows the ratios of ambient light intensities to be proportional, as follows:

$$\frac{{I}_{a m bient meas b}}{{I}_{a m bient meas r}} ≅ \frac{{I}_{ambient pre b}}{{I}_{a mbient pre r}} . \qquad Eq . 13$$

In situations where this assumption is valid, the characterization module can determine the difference between the measured blue light and pre-sampled blue light from the first illuminant and then use ensemble averaging to obtain an accurate estimate of the change in baseline. This change may be presumed to be due to a change in the ambient light. Then, the characterization module can add that amount of change and a proportional amount to the measured red light from the second illuminant, assuming that the signal gain and flash intensity are constant. Thus, the 1/f noise in each illuminant and the image sensor analog-to-digital converter (ADC) may therefore be critical to performance. Now, the measured image and pre-sampled image may be nominally equivalent except for the fact that the red light is emitted from the second illuminant rather than the first illuminant, and therefore is emitted at a different angle. So the intensity of each pixel may change by a small amount that is related to the target distance at that point in the field of view of the image sensor.

At this stage, the characterization module may select a trial range to target, and from the known shape of the target, may determine the pixel-dependent scale factors and then calculate the expected change in color difference resulting from the red light being emitted from the second illuminant rather than the first illuminant. The characterization module can vary the range until it finds the best fit to the ambient-corrected color differential. As an example, assume that ambient light is 10 percent of the red channel signal and 5 percent of the blue channel signal. In a subsequent measurement, the ambient light (e.g., due to flicker) is scaled by 0.95 for the red channel and 0.94 for the blue channel. The overall color error in the measurement is now about 1 percent of 10 percent (i.e., 0.001). This may be too large a change for color sensitivity for many applications.

One solution is to take a shorter exposure and/or a brighter flash. For example, if a 10 times shorter exposure is coupled with a 10 times brighter flash, then the ambient light will be 1 percent and the color change will be 0.0001. This is more manageable, though further improvement may be possible.

A measurement of ambient light—with the flash off—can be performed before and after an image is recorded, and then the average of those measurements can be used to interpolate the expected ambient color during the measurement exposure. For example, the ratio of the red and blue channels may be 2.401 before the image is recorded and 2.399 after the image is recorded. The characterization module may assume a ratio of 2.400 for the measurement. For a sine oscillation at the power frequency (e.g., two times the line frequency), minimal error occurs at the nodes where the signal is linear. Maximal residual error occurs at the peaks and valleys where the signal is quadratic. If faster sampling of the ambient light color is available, a second- or higher-order fit can better approximate the ambient light color. Accordingly, the computing device may include a fast, accurate linear sensor for tracking intensity or color of the ambient light, and after a measurement in conjunction with a flash, for synchronizing the linear sensor.

If the flicker frequency is known, then the exposure should preferably be done at a multiple of the flicker period with a sync filter null at the flicker frequency. Shorter duration measurements are most comparable if taken during the same phase of the flicker waveform. Thus, the characterization module may attempt to “lock” the phase of the flicker waveform to the ambient flicker.

An additional help is to choose color channels in which the ambient illumination is minimal. Indoor light sources, such as fluorescent bulbs and LEDs, are generally engineered to produce mostly visible light. Incandescent bulbs, meanwhile, are generally engineered to produce mostly infrared light with small amounts of blue light. Embodiments of the computing device may include (i) a multi-channel light source that is able to produce light of different colors or (ii) multiple light sources that are able to produce light of different colors. These different colors can be selected for range measurement based on where the ambient light spectrum multiplied by the sensor responsivity curve produces the smallest signal.

Alternatively, these different colors may be chosen for maximal spectral orthogonality. For example, a cyan LED designed to emit light between 475-500 nanometers (nm) and a red LED designed to emit light between 600-625 nm may produce minimal spectral overlap on red and blue subpixels as shown in FIG. 3. FIG. 3 illustrates how colors can be selected to maximize spectral orthogonality, thereby minimizing spectral overlap. Simply put, colors may be chosen for the illuminants in an effort to reduce spectral overlap on subpixels of different colors.

In some embodiments, spectral filters are situated over the illuminants. These spectral filters could be integrated monolithically during manufacturing of the illuminants, or these spectral filters could be assembled over the illuminants at the module level after manufacturing of the illuminants is complete. At a high level, these spectral filters can be used to narrow the spectral distribution of the illuminants to minimize spectral overlap on the pixels. As an example, a spectral filter could be deployed in an effort to remove or lessen emission tails at short or long wavelengths.

### D. Multi-Exposure and Associated Motion Sensitivity

For measurements that require multiple exposures, there is also the issue of motion of the target within the field of view of the image sensor. This can be due to motion of the image sensor itself (e.g., if the computing device is tilted upward or downward), mechanical vibration, or voluntary or involuntary motion of the target.

To deal with this motion, both illuminants can be measured simultaneously using the aforementioned method of spectral discrimination, namely, where different wavelengths are detected on different subpixels. However, to improve fidelity, it may be necessary to premeasure the ambient light as well as repeat some measurements.

To correct for motion, images generated by the image sensor can be shifted and re-interpolated to maximize the overlap. Problems can arise where the shape of the target changes (e.g., due to talking, chewing, blinking), barrel or pincushion distortion occurs, or there is reduced pixel response (e.g., from Fresnel losses in lenses or vignetting) in the corners and edges that limits the equivalence of shifted images. Additionally, there is the problem of fixed pattern noise, where column parallel ADS may have different gain for example. To address or circumvent these problems, (i) flash intensity may be kept in the linear emission range of the illuminants and pixels and (ii) each image may be cropped to a suitable central region where distortion is tractable and response from the image sensor is relatively flat. Ensemble averages of pixels can be used to lessen (e.g., minimize) fixed pattern noise.

Additionally or alternatively, the effects of color change could be reduced by taking multiple measurements, where each measurement corresponds to capture of an image. Assume, for example, that two measurements are taken, where the first measurement is taken with red light being emitted from the second illuminant position and blue light being emitted from the first illuminant position and the second measurement is taken with red light being emitted from the first illuminant position and blue light being emitted from the second illuminant position. By adding the color differences, the characterization module can gain a \sqrt{2} advantage in fidelity due to improved ambient light averaging and noise averaging. Accordingly, the computing device may provide independently controllable, multi-color light sources at two or more positions.

### E. Target Lambertian Scattering Assumption

The embodiments described so far rely on the assumption that the scattering of light off the surface of the target is independent of angle, resulting in a cosine intensity distribution. Said another way, the embodiments rely on the assumption that the light emitted toward the target will experience Lambertian scattering. Few materials are actually perfect Lambertian scatterers, however. Most materials, including human skin, have some sheen. The term “sheen” is generally used to refer to the visible luster of a material, and it relates to the specular reflectance of the material. Sheen corresponds to the light that is reflected by the material at its surface without interacting with the material itself, and therefore is not affected by its scattering and absorbing properties. This is the “hot spot” in an image taken in conjunction with a flash. The color of the hot spot is different than light scattered by the material in that it is roughly comparable to reflection by a mirror. Said another way, the hot spot may appear visually similar to the flash itself.

To establish the color of the target, the characterization module is interested in the scattered light, not the specular reflection. The characterization module can obtain information regarding the scattered light in several ways. First, the characterization module could identify the hot spot in an image and then ignore or remove the corresponding pixels from its analysis—effectively excising the hot spot from the image. Second, since polarization can be maintained on specular reflection, a polarized illuminant and a polarizer on the image sensor could be used to reject light that is specularly reflected. A polarizer is an optical filter that allows light of a specific polarization while blocking light of other polarizations. With the polarized illuminant and polarizer, only light that is scattered by the target may be received by the image sensor. Embodiments could employ the first solution, the second solution, or the first and second solutions. Note, however, that because roughly half of the light could be lost at the source due to polarization of the illuminant and roughly half of the scattered light could be lost at the image sensor due to the polarizer, it may be preferable to employ the first solution.

If the target is approximately in front of the illuminant, then specular reflection will be close to normal incidence and circularly polarized light will change helicity upon reflection by the target. Accordingly, a circular polarizer could be situated over the light source of which the illuminant is a part and the image sensor in order to reduce the artifacts that would be expected from linearly polarized light acting on a surface with anisotropic polarizability. The circular polarizer could be the same polarizer that rejects specularly reflected light, or the circular polarizer could be a different polarizer. As mentioned above, embodiments may not include a polarizer for rejecting specularly reflected light, and thus the circular polarizer may be the only polarizer situated over illuminant.

Another assumption is that the function that governs scattering is not strongly correlated with wavelength. Said another way, another assumption is that the function is not a strong function of wavelength. Most materials scatter more strongly at shorter wavelengths, and most materials—especially natural ones—scatter and absorb more weakly (i.e., have deeper penetration depth) in the near infrared range. Aside from such effects, strong wavelength-dependent scattering is not observed in most materials, though there are a few exotic or engineered materials that are exceptions.

To minimize wavelength effects, embodiments may use illuminants that emit light at wavelengths less than or about an octave (e.g., factor of two) apart. For example, a computing device may include an illuminant that emits cyan or green light and an illuminant that emits orange or red light. Additionally, the symmetric measurement described above—where the illuminant positions are swapped in sequential exposures—can help regularize wavelength-dependent scattering effects.

The symmetric measurement can also be generalized to a series of alternating measurements, where each illuminant is modulated at a particular frequency. But rather than the typical modulation where light is measured as (i) on/off or (ii) intensity level, the location of the light is instead modulated. For example, the location from which light of a given color (e.g., red or blue) is emitted can shift laterally across the surface of the computing device as the light is emitted by different illuminants. Accordingly, modulation at a particular frequency may indicate the stereoscopically observed difference in reflectivity particular to the angle to the target's surface.

In the event that the illuminants do not provide the same intensity, the characterization module may scale measurements from one intensity (e.g., the brighter intensity) to attempt to minimize the differentials relative to the prediction from the machine learning algorithm. This is conceptually comparable to digitally “centering” an object.

### F. Illuminant Emission Stability Over Time, Drive Level, and Temperature

Repeatability of the flash is an important aspect of producing accurate measurements. Changes in the relative intensity of the noise or drift between illuminants can cause a shifting baseline or offset to the estimated range. Intensity from solid-state sources, such as LEDs and diode lasers, is also dependent on drive current and junction temperature, which can vary.

Accordingly, some embodiments of the computing device include a temperature sensor for monitoring the temperature of the illuminants contained therein. For example, the computing device may include a temperature sensor for each illuminant, and each temperature sensor may be located proximate to the corresponding illuminant. As another example, temperature sensors may be spaced between the illuminants, in which case the temperature of a given illuminant may be computed, inferred, or otherwise determined based on the values output by its neighboring temperature sensors. With the values output by the temperature sensors, the characterization module can scale the relative color channel responses of the image sensor to compensate for temperature changes of the illuminants.

Additionally or alternatively, the computing device may include a temperature sensor for the image sensor to enable relative scaling of the color channels. For some image sensors (e.g., CMOS image sensors), responsivity of the channels has different temperature coefficients. Accordingly, the characterization module may apply different temperature correction scaling to the respective color channels based on the respective temperature coefficients and the temperature as read by the temperature sensor.

In some embodiments, the characterization module is able adjust the current supplied to each illuminant for driving purposes in order to compensate for variations in temperature, so as to provide a desired output brightness in a more consistent manner. Thus, the characterization module may monitor the outputs produced by the temperature sensors and then determine, based on the outputs, whether a change in the drive current for any illuminant is necessary. This could be done continually (e.g., in real time as values are output by the temperature sensors) or periodically (e.g., once per day, week, or month, or in response to a determination that the illuminants have been used for a predetermined amount of time).

The characterization module may also adjust a color correction matrix to compensate for spectral changes of the illuminants due to temperature. At a high level, the color correction matrix includes entries that indicate, for a desired light to be produced as output, how each illuminant should be driven. Each entry may be representative of a color model (or simply “model”) that indicates how to achieve the corresponding color. As the illuminants experience spectral changes, the characterization module may update the color correction matrix. Generally, the color correction matrix is stored in memory of the computing device of which the illuminants are a part, though the color correction matrix could be stored in another memory (e.g., one accessible to the computing device via a network).

To maximize the SNR, the received signal should be as large as possible within the useful linear range of the image sensor and its pixels. Accordingly, a method of operating the computing device may involve adjusting the currents supplied to the illuminants to ensure that the image sensor pixel responses in a target region are within a target range or match a target level. As mentioned above, the color correction matrix can be adjusted based on the temperature and currents to minimize crosstalk for specific illuminant conditions. Since the target color varies, brightness of some or all of the illuminants may be increased to boost response for a given channel that is getting lower reflection from the target. While conventional image sensors rely on a fixed color flash in order to maintain color fidelity, the system described herein can be operated differently in an effort to level the color response.

As an example, the system may run quasi-continuously in a mode where the characterization module attempts to control brightness of the second illuminant in a closed loop manner, so as to null the difference between the reflection the first illuminant and second illuminant positions. Changes in the current supplied to the second illuminant may be indicative of changes in range. Because the changes are negligible, this approach is more similar to analog control or variation of on-time duration, rather than a data acquisition approach. In some embodiments, on-time of the illuminant is used instead of current variation since the image sensor is an integrator. Clock speeds of the controller that manages the system (and, more specifically, managing supply of current to the illuminants) are typically in the range of hundreds of megahertz, so timing control on the order of nanoseconds can be done precisely. Adjustments on the order of microseconds may even be feasible, even for millisecond-scale flashes. For duty-cycle varied illumination, the computing device may include an image sensor with a global shutter. The term “global shutter” may be used to refer to image sensors that are able to scan the entire area of an image simultaneously, in contrast to “rolling shutters” in which the image is scanned sequentially from one side of the image sensor to the opposite side, line by line.

Illuminant current driver stability requirements would seem to need to be on the same level of precision; however, if the illuminants are simultaneously measured, the same driver may be able to source current to both illuminants via a current mirror. A current mirror is a circuit that is designed to copy a current through one active component (e.g., a first illuminant) by controlling the current in another active component (e.g., a second illuminant) of a circuit, keeping the output current roughly constant regardless of loading. First-order fluctuations in intensity can cancel in the difference, which typically “buys” at least two orders of magnitude in common mode cancellation. The 1/f noise or drift in the governing current can therefore be cancelled or mitigated to a large extent. However, care needs to be taken to avoid the 1/f noise and drift affecting the current mirror, such that it is not a limiting component in the signal chain. The simultaneous use of illuminants corresponding to orthogonal spectral channels can potentially alleviate a major design constraint.

By combining hardware, firmware, or software in a compact form as discussed above, the system can provide notable benefits in comparison to more conventional illuminating and imaging systems. Not only can the complexity of three-dimensional imaging and depth sensing be dramatically reduced, but techniques for establishing time-of-flight through the use of structured light (e.g., in the form of an infrared laser) may be rendered largely, if not entirely, obsolete. While a computing device could still include a time-of-flight sensor in addition to the system, the time-of-flight sensor could be eliminated in favor of an approach to shape estimation and flash parallel that relies on machine learning as discussed above. With machine learning, only a single imaging pipeline may be required.

Another solution that may be enabled by this system is accurate remote color and shade determination for targets like faces and textiles, for applications such as health, beauty, and e-commerce, where color from images is typically dependent on the lighting condition used during the capture of the image and varies with the tilt of the target. For example, it may be difficult from a cropped image to determine whether a target's shade is fading to one side or whether the target is actually bending or tilting away from the light source.

The system described herein may also be useful in multispectral imaging in health applications. Dermatological features in the skin are more visible—and therefore conditions are more readily diagnosable—when a multispectral image is transformed to a spectral basis that enhances features such as hemoglobin, ultraviolet-damaged areas, melanin, and the like. The term “multispectral image” may be used to refer to an image that includes more information than just red, green, and blue values on a per-pixel basis. For example, multispectral images may include ultraviolet or infrared values. At a high level, a curved surface can be “unwrapped” to capture the actual color and shade of the target in each location, not the apparent shade viewed from one location. Examples of curbed surfaces include anatomical features, such as the face, arm, or hand. Accordingly, tracking of changes in dermatological features may be accomplished through periodic measurements and updates to a model of the target. In particular, infrared sensitivity may be desirable for detection of dermatological features that originate or penetrate deeper in the skin, such as acne, moles, and cancer.

Multispectral images can be captured with a multispectral image sensor featuring spectral-selective subpixels, or multispectral images can be captured with an RGB or RGB-IR image sensor with a four subpixel array in combination with a multispectral light source. One example of a multispectral light source is an array of illuminants that span the visible and non-visible (e.g., ultraviolet or infrared) ranges.

The characterization module may build a model of a target, such as a face, and then use the illuminant parallax method described above to fix the absolute distance, thereby lending an absolute scale to the size of the object. Thereafter, if there are minimal changes to the target—a reasonable assumption for short-term studies of features like dermatological features—a multispectral image sensor may not need three-dimensional sensing. Instead, the image could be fit to a rotated and scaled model of the target.

Assume, for example, that the target is a face. In such a situation, facial analysis may involve generating a facial model from one or more images of the face, capturing depth information through illuminant parallax, and determine—based on the depth information—the absolute scale of the face at a first distance from the illuminant. Further away, uncertainty in depth will generate less uncertainty in shade. Thereafter, a multispectral image can be captured, for example, using a multispectral light source and an RGB-IR image sensor at a second distance. The second distance may be shorter than the first distance, or the second distance may be further than the first distance. At a shorter distance, higher resolution dermatological features can be analyzed on a known model indicating the target's shape and size.

Depth information could also be used for distance estimation to scale a three-dimensional model of a target. Beneficially, the model can act as a base over which to map features of interest not only along the surface, but also at deeper levels. Examples of features of interest include acne, pores, cancer, variations in color, chemical composition, or texture that may be indicative of health, appearance, aging, damage (e.g., from the sun), mood, temperature, and blood flow (e.g., in terms of distribution or circulation). Interpolation of a model together with a high-resolution image allows features to be tracked at a finer scale than with a three-dimensional image sensor alone. Those skilled in the art will recognize that this modeling could be performed by the characterization module or another computer program.

Comparing illumination from co- and cross-polarized sources may allow for determination of specular reflection (e.g., characterized as gloss or sheen), which may further allow for improved models to inform physics-based rendering methods. Knowledge of specular reflection may also allow for extraction, computation, or determination parameters for features related to surface reflectivity, such as skin moisture, oil presence, and the like.

Adding a third illuminant (or a third illuminant group) in a direction that is roughly orthogonal to the direction between the first and second illuminants may permit the system to determine depth for surfaces that are at a nonoptimal angle relative to the first and second illuminants, namely, close to the null, but which are not near a null for the first illuminant or the second illuminant relative to the third illuminant.

Three-dimensional models can be made by the characterization module (or another computer program) using estimates that are computed, inferred, or otherwise determined from two-dimensional images of the target. Once depth information is obtained, the distance to various locations along the model can be established. The model can be used for measurements over a short-term duration (e.g., minutes or days) without needing to recalibrate the size. For longer-term usage (e.g., weeks or months), the model can be updated to track physiological changes to facilitate discover of variations in height, weight, and the like.

### G. Spectral Capture

To record a multispectral image with multiple illuminants, if one image is captured per illuminant, the time requires to obtain the necessary images will increase with spectral resolution. Simply put, the time will increase as the number of color channels increases. Another problem is that the target may move, or the ambient light may change, so colors are being collected by the image sensor from nonequivalent images. Ideally, it is preferable to illuminate all of the illuminants at once. However, these color channels may not be fully distinguishable on an image sensor with a limited number of channels, such as an RGB or RGB-IR image sensor. Additionally, temporally synchronizing flashes by the illuminants with capture of images by the image sensor can be difficult, especially at high frame rates (e.g., over 120 hertz). Accordingly, a method for parallel collection of data from multiple illuminants in a manner that distinguishes illumination from more sources than the image sensor has channels is desired. Especially one in which synchronization is not needed between the multiple illuminants and image sensor.

As with stereoscopy, frequency domain multiplexing or certain types of coded multiplexing that are phase invariant may be used. If the computing device is used to perform a temporary interrogation of a target with a flash, rather than provide ambient light to the ambient environment, then perceived flicker is not a concern. As such, aliasing or modulating at visibly noticeable frequencies is not a problem. A temporal series of images (also called a “stack of images”) can be acquired in which the number of images provides a measure of frequency resolution. For adequate frequency resolution, the duration of the stack should be large (e.g., greater than 2, 5, or 10 times) compared to the period of the lowest frequency or alias of interest.

Suppose that a computing device includes 10 illuminants, and that the difference between each modulation frequency is 10 hertz (Hz), for example, spanning the range of 10 Hz to 100 Hz. If one second of data is collected at 250 frames per second, the sample rate is sufficient to resolve the highest frequency. With one second of data, there will be about 2 Hz of useful resolution, so peaks can be resolved in the power spectrum of a discrete Fourier transform or wavelet transform. In practice, all of the frequencies could be shifted up (e.g., by 5 Hz) to avoid 50 Hz and 60 Hz, which are power line frequencies. Thus, the modulated (and shifted) frequencies could be 15 Hz, 25 Hz, 35 Hz, etc.

Note that because square-wave modulation contains harmonics, sine-wave modulation may be preferred where harmonics could collide with another modulation channel. If square-wave modulation is desired, then the system may implement an orthogonal coding scheme to prevent harmonic collision. However, the orthogonal coding scheme may put restrictions on the desired frequencies.

If suppression of numerical artifacts or frequencies from residual nonlinearity is desired, then the spacing of the frequencies may be adjusted away from regular intervals or slightly “chirped,” such that the difference between adjacent channels varies, increases steadily, or decreases steadily. For example, the frequency may begin at an initial value (e.g., 5 Hz) and then increase at a fixed rate (e.g., by 5 Hz, then 6 Hz, then 7 Hz, etc.). Similarly, the frequency may begin at an initial value (e.g., 5 Hz) and then decrease at a fixed rate (e.g., by 20 Hz, then 19 Hz, then 18 Hz). Alternatively, the spacing may vary in a random or semi-random manner.

In computing devices where the imaging pipeline is part of a closed system (e.g., a preprogrammed, embedded system), it may be difficult to precisely synchronize each illuminant with the image sensor. Using the modulation scheme of each illuminant, each illuminant can be driven independently of the image sensor, such that no synchronization is necessary. To achieve this, the characterization module may perform a method that entails the following. First, the characterization module can cause the illuminants to be modulated in a predefined sequence over the course of an illumination period. For example, the characterization module may generate signals that are representative of instructions to the computing device of how to drive the illuminants in accordance with the predefined sequence. The predefined sequence may be repeated as necessary. Second, the image sensor can acquire a stack of images during the illumination period. Third, the characterization module can cause modulation of at least one of the illuminants that is used to clock image sensing.

Embodiments may be described in the context of dedicated illuminants (e.g., LEDs) that are arranged along the same side of the computing device as the image sensor. However, the display panel of the computing device could serve as one or more illuminants in some embodiments, so long as the image sensor faces the same direction (e.g., as is the case for a front-facing camera of a mobile phone). In such embodiments, the image sensor is able to view targets that are illuminated by the display panel. As mentioned above, either the entire display panel or a portion of the display panel could be used to illuminate the target in accordance with the desired modulated color sequence. In other embodiments, the illuminants are located along the rear side of the computing device, in which case the image sensor may be included in a rear-facing camera.

Conventionally, illuminants and image sensors have been operated in synchronous fashion, where one color is emitted during one exposure of an image sensor. This requires that illuminants and image sensors be synchronized, however. This can pose problems, for example, for image sensors with rolling shutters where the exposure across the image varies in time. Also, motion artifacts can build up over successive images, making images taken at different wavelengths less equivalent. Accordingly, modulating illuminants via a code domain multiplex or frequency domain multiplex offers advantages as synchronization is not necessary. Since color of an illuminant can change—especially during bright illumination as the illuminant heats up—having multiple illuminants that can collectively operate at lower brightness with regular modulation can provide a more stable color output. Changes may need to be made to the heat sink used by this array of illuminants to account for the added heat.

As discussed above with reference to FIG. 2A, the illumination parallax method may use portions along the edges of the display panel to increase the distance between the pixels providing the illumination. While the portions are shown as lines extending along an entirety of the opposing sides of the display panel, those skilled in the art will recognize that other shapes could be used. For example, the opposing corners could be used to illuminate the target.

As shown in FIG. 3, the display panel could be used to illuminate the target whether the computing device is in the portrait orientation or landscape orientation. However, landscape orientation may be preferred since greater illumination could be provided due to the larger number of pixels, and a user may be instructed to place the computing device in the landscape orientation before the illumination parallel method is performed. In embodiments where portions of the display panel are used as the “illuminants,” the portions can be modulated at different frequencies or via orthogonal codes. Thus, the differential illumination information may be encoded in the time domain, frequency domain, or orthogonal code domain.

In embodiments where the display panel is used to illuminate the target, different regions of the display panel could be operated in sequence to provide illumination parallax. Assume, for example, that the target is initially illuminating by operating a first set of opposing sides of the display panel that extend in a first direction (e.g., the latitudinal direction while the computing device is held in the landscape orientation). Thereafter, the target can be illuminated by operating a second set of opposing sides of the display panel that extend in a second direction (e.g., the latitudinal direction while the computing device is held in the portrait orientation). Relocating these illumination regions may allow the characterization module to obtain differentials along different directions, which can help to reduce differential nulls.

### H. Subsurface Scatter Measurement

Embodiments of the system may be able to characterize targets, such as the skin of a human body, by providing a structured illuminant. That means that the illuminant can create a spatially varied illumination profile on the human body. Ideally, the spatially variations should be defined by a sharp edge. While subsurface scatter in materials like skin can blur such edges, imaging of the structured light emitted by the illuminant and subsequent analysis can establish the amount of subsurface scatter. The amount of subsurface scatter may be related to properties of the target. This process can be performed at one or more wavelengths as desired.

As an example, if a laser pointer is shone at a finger, the entire finger generally lights up. This is caused by subsurface scatter. Simply put, it means that the light leaves the target—in this case, the finger—from a different point than where the light entered the target.

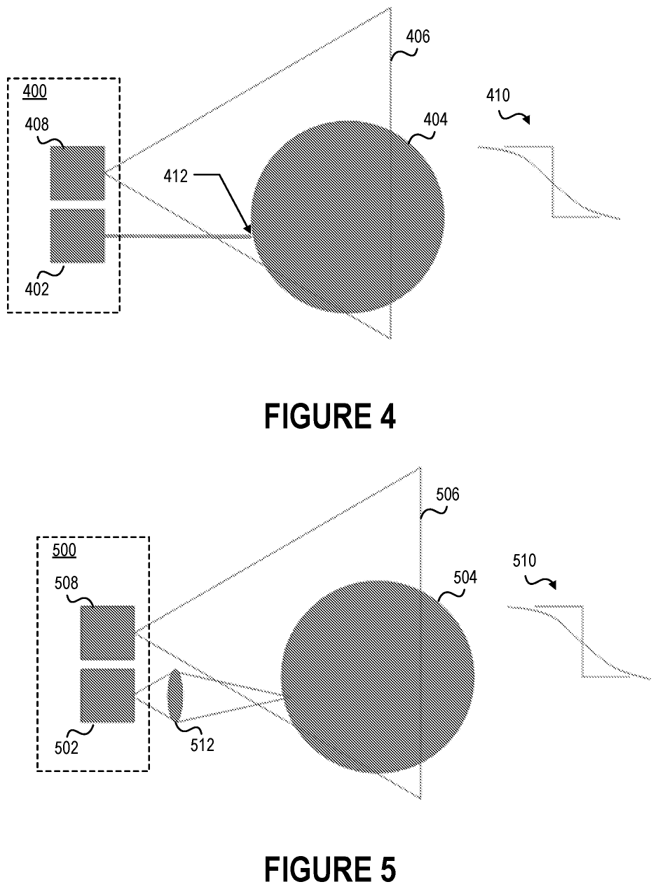

In some embodiments, the structured light is a laser. FIG. 4 includes a diagrammatic illustration of a laser 402 that is illuminating a target 404 that resides within the field of view 406 of an image sensor 408. As shown in FIG. 4, the laser 402 and image sensor 408 may be part of a computing device 400. An intensity profile 410 is also shown in FIG. 4. The intensity profile 410 is in the radial direction of the laser spot 412, which will be “sharp” on targets without meaningful subsurface scatter but which will broaden on targets with subsurface scatter.

Alternatively, the structured light may be a laser-generated pattern. For example, a pattern of dots or a grid of lines may be emitted toward the target of interest. Multiple illumination “points” may be preferred over a single illumination “point” for safety reasons, as well as for improved user experience. With multiple illumination “points,” it may be easier for a user to position the computing device so that the target is inside the field of view of the image sensor.

In some embodiments, the structured light is non-visible light. For example, the structured light may be infrared light, so as to lessen the likelihood of inadvertently harming the eyes (e.g., of the user or another individual). In other embodiments, the structured light is visible light. For example, the structured light may be emitted by a source such as an LED or bulb filament. FIG. 5 includes a diagrammatic illustration of an illuminant 502, such as an LED, that is illuminating a target 504 that resides within the field of view 506 of an image sensor 508. As shown in FIG. 5, the illuminant 502 and image sensor 508 may be part of a computing device 500. An intensity profile 510 is also shown in FIG. 5. The intensity profile 510 at the edge of an image generated by the image sensor 508 will be sharp on targets without subsurface scatter but will broaden on targets with subsurface scatter. By comparing FIG. 5 to FIG. 4, one can see that the light emitted by the illuminant 502 can be focused (e.g., via a lens 512) toward the target 504 but may not form a “spot” in the same way that the laser 402 of FIG. 4 does.

LEDs typically have rectangular shapes with sharp edges, as well as current-spreading features on their surfaces that correspond to regions with less light, all of which can be used to observe the blurring effect of subsurface scatter. Whether the structured light is visible or non-visible, the structured light could have multiple illumination “points” as mentioned above.

The structured light could be used to obtain depth information, for example, based on the parallax of structured light. At a high level, the characterization module may utilize the knowledge that the closer the target, the more the structured light will move off-center in the image. The depth information can then be used to calculate one or more relevant illuminant parameters, such as magnification, size, defocus, and the like. Depth information could also be used to estimate a target surface angle and correct for the projection error in the observed subsurface scatter.

### Overview of Light Sources

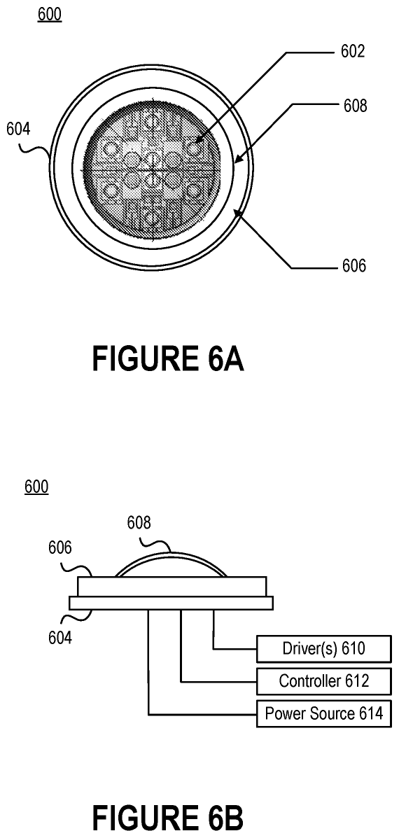

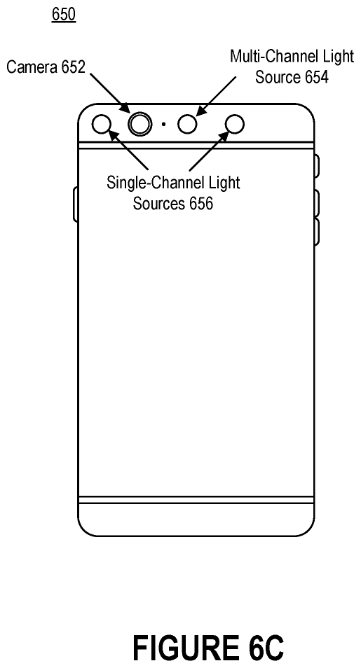

As shown in FIG. 3, portions of the display panel of a computing device could be used as “illuminants.” Alternatively, the computing device could include dedicated illuminants as discussed below with reference to FIGS. 6A-8.

FIG. 6A depicts a top view of a multi-channel light source 600 that includes multiple color channels able to produce different colors. Each color channel can include one or more illuminants 602 designed to produce light of a substantially similar color. For example, the multi-channel light source 600 may include a single illuminant configured to produce a first color, multiple illuminants configured to produce a second color, etc. Note that, for the purpose of simplification, a color channel may be said to have “an illuminant” regardless of how many separate illuminants the color channel includes.

As mentioned above, one example of an illuminant is an LED. An LED is a two-lead illuminant that is generally comprised of an inorganic semiconductor material. While embodiments may be described in the context of LEDs, the technology is equally applicable to other types of illuminant.

A light source 600 may include multiple color channels that are associated with different colors. For example, the light source 600 may include two separate color channels configured to produce blue light and red light. Such light sources may be referred to as “RB light sources.” As another example, the light source 600 may include three separate color channels configured to produce blue light, green light, and red light. Such light sources may be referred to as “RGB light sources.” As another example, the light source 600 may include four separate color channels configured to produce blue light, green light, red light, and either amber light or white light. Such light sources may be referred to as “RGBA light sources” or “RGBW light sources.”

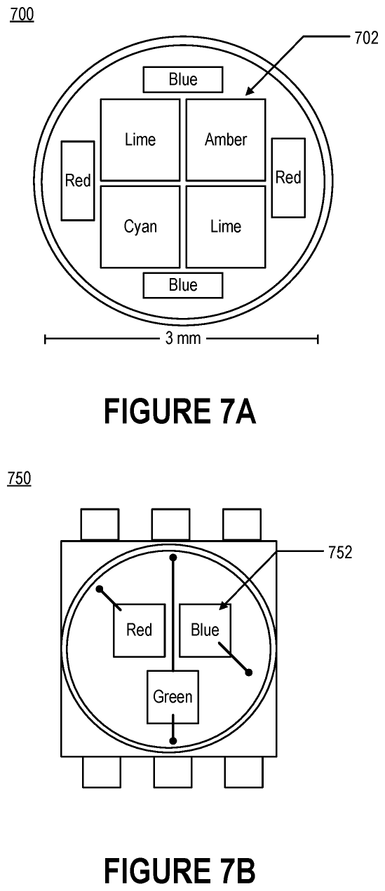

Due to their low heat production, LEDs can be located close together. Accordingly, if the illuminants 602 of the multi-channel light source are LEDs, then the light source 600 may include an array comprised of multiple dies placed arbitrarily close together. Note, however, that the placement may be limited by “whitewall” space between adjacent dies. The whitewall space is generally on the order of approximately 0.1 millimeters (mm), though it may be limited (e.g., to no more than 0.2 mm) based on the desired diameter of the light source 100 as a whole. In FIG. 7A, for example, the array includes eight dies associated with five different color channels. FIG. 7B, meanwhile, shows an array that includes three dies associated with three different color channels. FIG. 7B also shows how LEDs tend to have definite edges, and when current spreaders are situated therebetween, can produce “sharp” illumination when emitted towards a target, Such arrays may be sized to fit within similar dimensions as conventional flash technology.

As shown in FIG. 6B, the array may be driven by one or more drivers 610. The drivers 610 could be, for example, linear field-effect transistor-based (FET-based) current-regulated drivers. In some embodiments, each color channel is driven by a corresponding driver. These drivers 610 may be affixed to, or embedded within, a substrate 604 arranged beneath the illuminants 602. By independently driving each color channel, the light source 600 can produce light of different colors. For example, the light source 600 may emit a flash of red light that illuminates a scene in conjunction with the capture of a first image and then emit a flash of blue light that illuminates the scene in conjunction with the capture of a second image.

Unlike traditional lighting technologies, the light source 600 can be handled such that the output of each channel is known at all times. Using information such as temperature and driving current, a controller 612 can (i) adjust the current provided to each channel and/or (ii) adjust the ratios of the channels to compensate for spectral shifts. One example of a controller 612 is a central processing unit (also referred to as a “processor”).

The light source 600 may be able to produce colored light by separately driving the appropriate color channel(s). For example, a controller 612 may cause the light source 600 to produce a colored light by driving a single color channel (e.g., a red color channel to produce red light) or multiple color channels (e.g., a red color channel and an amber color channel to produce orange light). The controller 612 may also be able to cause the light source 600 to produce white light by simultaneously driving each color channel. In particular, the controller 612 may determine, based on a color mixing model, operating parameters required to achieve the desired color. The operating parameters may specify, for example, the driving current to be provided to each color channel. By varying the operating parameters, the controller can tune the white light as necessary.

Although the illuminants 602 are illustrated as an array of LEDs positioned on a substrate 604, other arrangements are also possible. In some cases, a different arrangement may be preferred due to thermal constraints, size constraints, color mixing constraints, etc. For example, the light source 600 may include a circular arrangement, grid arrangement, or cluster arrangement of LEDs.

FIG. 6B depicts a side view of the light source 600 illustrating how, in some embodiments, the illuminants 602 reside within a housing. The housing can include a base plate 606 that surrounds the illuminants 602 and/or a protective surface 608 that covers the illuminants 602. While the protective surface 608 shown here is in the form of a dome, those skilled in the art will recognize that other designs are possible. For example, the protective surface 608 may instead be arranged in parallel relation to the substrate 604. Moreover, the protective surface 608 may be designed such that, when the light source 600 is secured within a computing device, the upper surface of the protective surface 608 is substantially co-planar with the exterior surface of the computing device. The protective substrate 608 can be comprised of a material that is substantially transparent, such as glass, plastic, etc.

The substrate 604 can be comprised of any material able to suitably dissipate heat generated by the illuminants 602. A non-metal substrate, such as one comprised of woven fiberglass cloth with an epoxy resin binder (e.g., FR4), may be used rather than a metal substrate. For example, a substrate 604 composed of FR4 may more efficiently dissipate the heat generated by multiple color channels without experiencing the retention issues typically encountered by metal substrates. Note, however, that some non-metal substrates are not suitable for high-power illuminants that are commonly used for photography and videography, so the substrate 604 may be comprised of metal, ceramic, etc.

The processing components necessary for operating the illuminants 602 may be physically decoupled from the light source 600. For example, the processing components may be connected to the illuminants 602 via conductive wires running through the substrate 604. Examples of processing components include drivers 610, controllers 612, power sources 614 (e.g., batteries), etc. Consequently, the processing components need not be located within the light source 600. Instead, the processing components may be located elsewhere within the computing device in which the light source 600 is installed.

As discussed above, the light source 600 may operate in conjunction with an image sensor. Accordingly, the light source 600 could be configured to emit light responsive to determining that an image sensor has received an instruction to capture an image of a scene. The instruction may be created responsive to receiving input indicative of a request that the image be captured, or the instruction may be created responsive to receiving input indicative of a request to determine the color and shade of a target that is within the field of view of the image sensor. As shown in FIG. 6C, an image sensor (here, included in a camera 652) may be housed within the same computing device as one or more light sources.

In some embodiments, the light source 600 is designed such that it can be readily installed within the housing of a computing device. FIG. 6C depicts a computing device 650 that includes a rear-facing camera 652 and multiple light sources that are able to illuminate the ambient environment. Some or all of these light sources could be multi-channel light sources. In FIG. 6C, for example, the computing device 650 includes a multi-channel light source 654 and multiple single-channel light sources 656. The multi-channel light source 654 may be, for example, the multi-channel light source 600 of FIGS. 6A-B. Meanwhile, the single-channel light sources 656 may be functionally comparable to the multi-channel light source 654, but only able to emit light of a single color. As mentioned above, the multi-channel light source 654 may be one of multiple light sources included in the computing device 650. The computing device 650 may include multiple multi-channel light sources that are arranged along the same side of its housing, or the computing device 650 may include a multi-channel light source and one or more single-channel light sources that are arranged along the same side of its housing as shown in FIG. 6C.

The rear-facing camera 652 is one example of an image sensor that may be configured to capture images in conjunction with light produced by the light source 600. Here, the computing device 650 is a mobile phone. However, those skilled in the art will recognize that the technology described herein could be readily adapted for other types of computing devices, such as tablet computers and digital cameras.

The camera 652 may be one of multiple image sensors included in the computing device 650. For example, the computing device 650 may include a front-facing camera that allows an individual to capture still images or video while looking at the display panel. The rear- and front-facing cameras can be, and often are, different types of image sensors that are intended for different uses. For example, the image sensors may be capable of capturing images having different resolutions. As another example, the image sensors could be paired with different light sources (e.g., the rear-facing camera may be associated with a stronger flash than the front-facing camera, or the rear-facing camera may be disposed in proximity to a multi-channel light source while the front-facing camera is disposed in proximity to the display panel that could be utilized as a multi-channel light source as discussed above).

FIGS. 7A-B depict examples of arrays 700, 750 of illuminants 702, 752. If the illuminants 702, 752 are LEDs, the arrays 700, 750 may be produced using standard dies (also referred to as “chips”). A die is a small block of semiconducting material on which the diode located. Typically, diodes corresponding to a given color are produced in large batches on a single wafer (e.g., comprised of electronic-grade silicon, gallium arsenide, etc.), and the wafer is then cut (“diced”) into many pieces, each of which includes a single diode. Each of these pieces may be referred to as a “die.”

As shown in FIGS. 7A-B, the arrays 700, 750 can include multiple color channels configured to produce light of different colors. Here, for example, the array 700 of FIG. 7A includes five color channels—blue, cyan, lime, amber, and red. Meanwhile, the array 750 of FIG. 7B includes three color channels—blue, green, and red. Each color channel can include one or more illuminants. In FIG. 7A, three color channels (i.e., blue, lime, and red) include multiple illuminants, while two color channels (i.e., cyan and amber) include a single illuminant. In FIG. 7B, each color channel includes a single illuminant. The number of illuminants in each color channel, as well as the arrangement of these illuminants within the arrays 700, 750, may vary based on the desired applications.

The arrays 700, 750 may be designed for installation within the housing of a computing device (e.g., computing device 650 of FIG. 6C) in addition to, or instead of, a conventional flash component. For example, some arrays designed for installation within mobile phones are less than 4 mm in diameter, while other arrays designed for installation within mobile phones are less than 3 mm in diameter. The arrays 700, 750 may also be less than 1 mm in height. In some embodiments, the total estimated area necessary for an array may be less than 3 mm² prior to installation and less than 6 mm² after installation. Such a design enables the arrays 700, 750 to be positioned within a mobile phone without requiring significant repositioning of components within the mobile phone.

While embodiments may be described in terms of LEDs, those skilled in the art will recognize that other types of illuminants could be used instead of, or in addition to, LEDs. For example, embodiments of the technology may employ lasers, quantum dots (“QDs”), organic LEDs (“OLEDs”), resonant-cavity LEDs (“RCLEDs”), vertical-cavity surface-emitting lasers (“VCSELs”), superluminescent diodes (“SLDs” or “SLEDs”), blue “pump” LEDs under phosphor layers, up-conversion phosphors (e.g., microscopic ceramic particles that provide a response when excited by infrared radiation), nitride phosphors (e.g., CaAlSiN, SrSiN, KSiF), down-conversion phosphors (e.g., KSF:Mn4+, LiAlN), rubidium zinc phosphate, yttrium-aluminum-garnet (YAG) phosphors, lutetium-aluminum-garnet (LAG) phosphors, SiAlON phosphors, SiON phosphors, or any combination thereof.

### Overview of Image Sensor

An image sensor is a sensor that detects information that constitutes an image. Generally, an image sensor accomplishes this by converting the variable attenuation of light waves (e.g., as they pass through or reflect off objects) into electrical signals, which represent small bursts of current that convey the information. Examples of image sensors include CCDs and CMOS sensors. Both types of image sensor accomplish the same task, namely, converting captured light into electrical signals. However, because CMOS sensors are generally cheaper, smaller, and less power-hungry than CCDs, many computing devices use CMOS sensors for image capture.

Image sensors can also differ in their separation mechanism. One of the most common separation mechanisms is a color filter array that passes light of different colors to selected sensor elements that are representative of subpixels. For example, each individual sensor element may be made sensitive to either red light, green light, or blue light by means of a color gel made of chemical dye. Because image sensors separate incoming light based on color, they may be said to have multiple sensor channels or multiple color channels. Thus, an image sensor that includes multiple sensor channels corresponding to different colors may be referred to as a “multi-channel image sensor.”

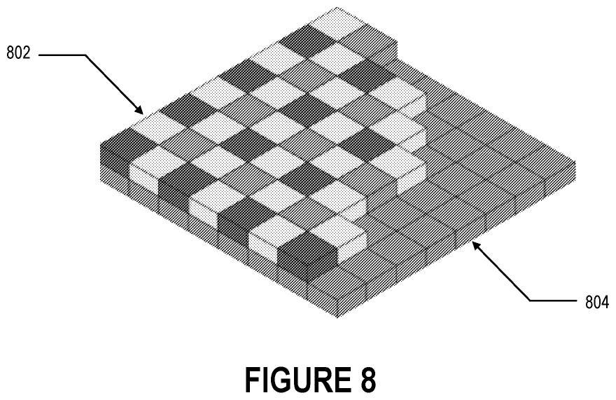

FIG. 8 depicts an example of a separation mechanism 802 arranged over an image sensor 804. Here, the separation mechanism 802 is a Bayer filter array that includes three different types of color filters designed to separate incoming light into red light, green light, or blue light on a per-pixel basis. The image sensor 804, meanwhile, may be a CMOS sensor. Rather than use photochemical film to capture images, the electronic signal generated by the image sensor 804 is instead recorded to a memory for subsequent analysis.

After a recording function is initiated (e.g., responsive to receiving input indicative of a request to capture an image), a lens focuses light through the separation mechanism 802 onto the image sensor 804. As shown in FIG. 8, the image sensor 804 may be arranged in a grid pattern of separate imaging elements. Generally, the image sensor 804 determines the intensity of incoming light rather than the color of the incoming light. Instead, color is usually determined through the use of the separation mechanism 802 that only allows a single color of light into each imaging element. For example, a Bayer filter array includes three different types of color filter that can be used to separate incoming light into three different colors (i.e., red, green, and blue), and then average these different colors within a two-by-two arrangement of imaging elements. Each pixel in a given image may be associated with such an arrangement of imaging elements. Thus, each pixel could be assigned separate values for red light, green light, and blue light. Another method of color identification employs separate image sensors that are each dedicated to capturing part of the image (e.g., a single color), and the results can be combined to generate the full color image.

### Overview of Characterization Module

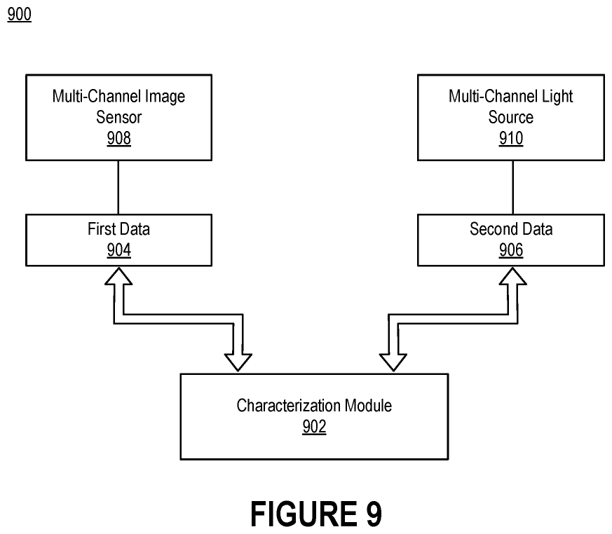

FIG. 9 depicts an example of a communication environment 900 that includes a characterization module 902 programmed to controllably illuminate a target and then examine images of the target to determine color and shade. The characterization module 902 could be implemented via software, firmware, or hardware. Accordingly, aspects of the processes described herein could be performed by software, firmware, or hardware. For example, these processes could be executed by a software program (e.g., a mobile application) executing on a computing device that includes a multi-channel image sensor and a multi-channel light source, or these processes could be executed by an integrated circuit that is part of the multi-channel image sensor or the multi-channel light source.

As shown in FIG. 9, the characterization module 902 may obtain data from different sources. Here, for example, the characterization module 902 obtains first data 904 generated by a multi-channel image sensor 908 (e.g., camera 652 of FIG. 6C) and second data 906 generated by a multi-channel light source 910 (e.g., light source 654 of FIG. 6C). The multi-channel light source 910 may be one of multiple light sources from which data is received. The first data 904 can specify, on a per-pixel basis, an appropriate value for each sensor channel. For example, if the multi-channel image sensor 908 includes three sensor channels (e.g., red, green, and blue), then each pixel will be associated with at least three distinct values (e.g., a red value, a green value, and a blue value). Each pixel may be associated with more than three distinct values if, for example, the multi-channel image sensor 908 is multispectral image sensor. The second data 906 can specify characteristics of each channel of the multi-channel light source 910. For example, the second data 906 may specify the driving current for each color channel during a flash, the dominant wavelength of each color channel, the illuminance profile of each color channel, etc.

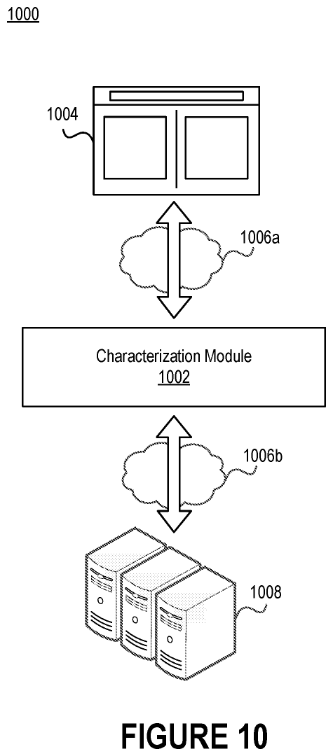

FIG. 10 illustrates a network environment 1000 that includes a characterization module 1002. In some embodiments, the characterization module 1002 is an integral part of the computing device on which it resides. For example, the characterization module 1002 may be part of, or accessible to, the operating system of the computing device. In other embodiments, the characterization module 1002 is representative of a computer program that can be selectively executed by the computing device, for example, upon receiving input indicative of a request to determine the color and shade of a target of interest.

Individuals may be able to interface with the characterization module 1002 via an interface 1004. As further discussed below, the characterization module 1002 may be responsible for driving illuminants to illuminate a target and then examining images of the target to establish characteristics thereof. The characterization module 1002 may also be responsible for creating or supporting interfaces through which an individual can view the images, initiate post-processing operations, manage preferences, etc.

The characterization module 1002 may reside in a network environment 1000 as shown in FIG. 10. Thus, the computing device that executes the characterization module 1002 may be connected to one or more networks 1006a-b. The networks 1006a-b can include personal area networks (PANs), local area networks (LANs), wide area networks (WANs), metropolitan area networks (MANs), cellular networks, the Internet, etc.

Generally, the characterization module 1002 resides on the same computing device as the multi-channel image sensor and the multi-channel light source. For example, the characterization module 1002 may be part of a mobile application through which a multi-channel image sensor of a mobile phone can be operated. In other embodiments, the characterization module 1002 is communicatively coupled to the multi-channel image sensor and/or the multi-channel light source across a network. For example, the characterization module 1002 may be executed by a network-accessible platform (also referred to as a “cloud platform”) that resides on a computer server.

In some embodiments, the characterization module 1002 is executed by a cloud computing service operated by Amazon Web Services®, Google Cloud Platform™, Microsoft Azure®, or a similar technology. In such embodiments, the characterization module 1002 may reside on a host computer server that is communicatively coupled to one or more content computer servers 1008. The content computer servers 1008 can include color mixing models, items necessary for post-processing such as heuristics and algorithms, and other assets.

### Exemplary Methodologies for Operating Computing Devices

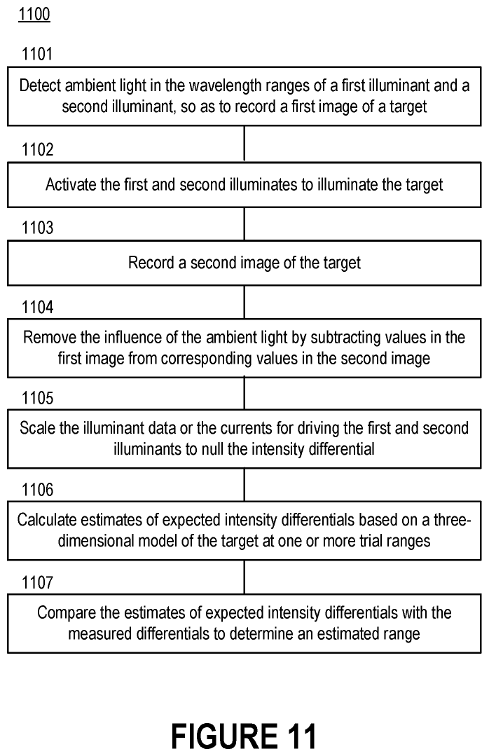

FIG. 11 includes a flow diagram of a process 1100 for determining an estimated range to a target from a computing device that includes (i) first and second illuminants, spaced apart with different wavelengths and (ii) an image sensor with spectral filtering subpixels. The illuminating and filtering spectra of the first and second illuminants and image sensor, respectively, may be chosen to reduce crosstalk on the subpixels of the image sensor. At a high level, the spectra may be chosen to ensure that one subpixel type (e.g., red) detects primarily the light emitted by the first illuminant while another subpixel type (e.g., blue) detects primarily the light emitted by the second illuminant.

Initially, the image sensor can detect the ambient light level in the wavelength ranges of the first and second illuminants (step 1101), so as to record a first image of the target that serves as a reference. Then, the computing device can activate the first and second illuminants (step 1102), and the image sensor can record a second image of the target (step 1103).

Thereafter, a characterization module can remove the influence of the ambient light by subtracting, on a per-pixel basis, values in the first image from corresponding values in the second image (step 1104). In some embodiments, the characterization module scales either the illuminant data or the currents for driving the first and second illuminants to null the intensity differential (step 1105). The characterization module can calculate estimates of expected intensity differentials based on a three-dimensional model of the target at one or more trial ranges (step 1106) as discussed above. Then, the characterization module can compare the estimates of expected intensity differentials with the measured differentials—namely, the values produced in step 1104—to determine the estimated range (step 1107).

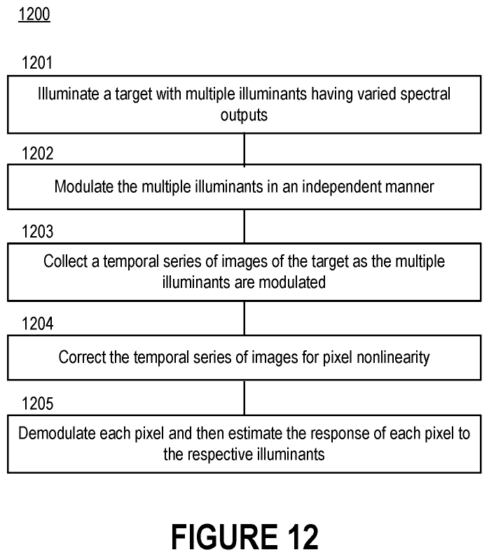

FIG. 12 includes a flow diagram of a process 1200 for estimating the in situ pixel-by-pixel nonlinearity via illumination of a target with multiple illuminants with distinct modulation frequencies, based on measurements of the intermodulation distortion. Initially, a computing device can illuminate the target with multiple illuminants having varied spectral outputs (step 1201). The number of distinct spectra should preferably be greater than the number of spectral filtering subpixels on the image sensor included in the computing device. Then, the computing device can modulate the multiple illuminants in an independent manner (step 1202). For example, the illuminants may be orthogonally modulated in the time domain, frequency domain, or code domain. As the multiple illuminants are modulated, the image sensor collect a temporal series of images of the target (step 1203). As discussed above, a characterization platform can then correct the temporal series of images for pixel nonlinearity (step 1204). Moreover, the characterization platform may demodulate each pixel and then estimate the response of each pixel to the respective illuminants (step 1205).

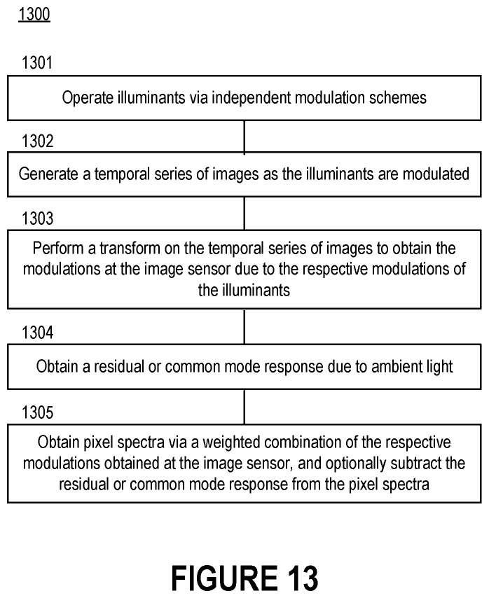

FIG. 13 includes a flow diagram of a process 1300 for obtaining pixel spectra for images generated by a computing device. The computing device may include illuminants having different spectral profiles. For example, the computing device may include an array of LEDs operable to emit light of different colors, or the computing device may include a display panel with different dominant wavelengths. Moreover, the computing device may include an image sensor operable to output images, for example, into memory of the computing device.

Initially, the computing device can operate the illuminants via independent modulation schemes (step 1301). For example, the computing device may operate the illuminants via orthogonal modulation schemes in the time, frequency, or code domain. As the illuminants are modulated, the image sensor can generate a temporal series of images (step 1302). Generally, modulation of the illuminants is not synchronized with capture of the images. Thus, modulation may be incommensurate at the rate at which the images are generated by the image sensor.

Then, a characterization module can perform a transform on the temporal series of images to obtain the modulations at the image sensor due to the respective modulations of the illuminants (step 1303). Through analysis of the temporal series of images, the characterization module may also obtain a residual or common mode response due to ambient light (step 1304). This residual or common mode response may vary in terms of time and space. The characterization module can then obtain the pixel spectra via a weighted combination of the respective modulations obtained at the image sensor (step 1305). In embodiments where the characterization module obtains the residual or common mode response, the residual or common mode response can be subtracted from the pixel spectra.

### Processing System

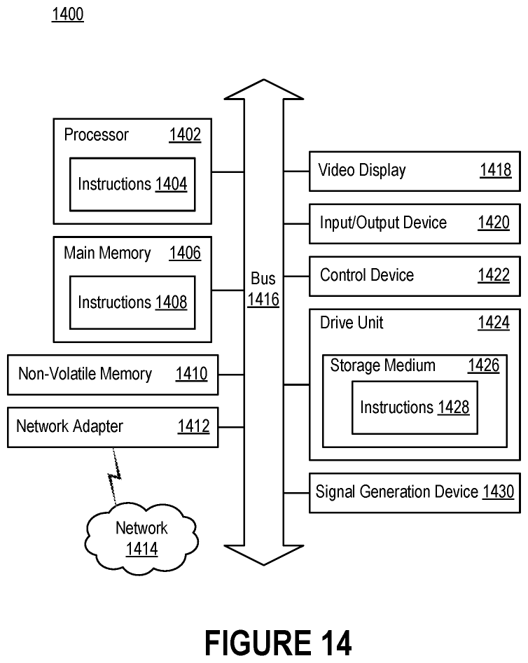

FIG. 14 is a block diagram illustrating an example of a processing system 1400 in which at least some operations described herein can be implemented. For example, components of the processing system 1400 may be hosted on a computing device that includes illuminants, an image sensor, and a characterization module.

The processing system 1400 may include a processor 1402, main memory 1406, non-volatile memory 1410, network adapter 1412, display panel 1418, input/output device 1420, control device 1422 (e.g., a keyboard or pointing device), drive unit 1424 including a storage medium 1426, and signal generation device 1430 that are communicatively connected to a bus 1416. The bus 1416 is illustrated as an abstraction that represents one or more physical buses or point-to-point connections that are connected by appropriate bridges, adapters, or controllers. The bus 1416, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I²C) bus, or an Institute of Electrical and Electronics Engineers (IEEE) standard 1394 bus (also referred to as “Firewire”).

While the main memory 1406, non-volatile memory 1410, and storage medium 1426 are shown to be a single medium, the terms “machine-readable medium” and “storage medium” should be taken to include a single medium or multiple media (e.g., a centralized/distributed database and/or associated caches and servers) that store one or more sets of instructions 1428. The terms “machine-readable medium” and “storage medium” shall also be taken to include any medium that is capable of storing, encoding, or carrying instructions for execution by the processing system 1400.

In general, the routines executed to implement the embodiments of the disclosure may be implemented as part of an operating system or a computer program. Computer programs typically comprise one or more instructions (e.g., instructions 1404, 1408, 1428) set at various times in various memory and storage devices in a computing device. When read and executed by the processor 1402, the instructions cause the processing system ′400 to perform operations to execute elements involving the various aspects of the present disclosure.

Further examples of machine- and computer-readable media include recordable-type media, such as volatile memory devices and non-volatile memory devices 1410, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 1412 enables the processing system 1400 to mediate data in a network 1414 with an entity that is external to the processing system 1400 through any communication protocol supported by the processing system 1400 and the external entity. The network adapter 1412 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computing device comprising:
a light source that includes a plurality of illuminants having different spectral emission profiles,
wherein the plurality of illuminants includes a first illuminant having a first spectral emission profile;
a second illuminant having a second spectral emission profile that is separated from the first illuminant of the light source by a spacing,
wherein the second spectral emission profile of the second illuminant is different than the first spectral emission profile of the first illuminant; and
an image sensor that includes a pattern of subpixels associated with varied spectral responses;
wherein the first and second spectral emission profiles of the first and second illuminants are selected so as to reduce spectral overlap on different subpixels.

2. The computing device of claim 1, wherein the varied spectral responses of the subpixels correspond to different colors in the visible spectrum.

3. The computing device of claim 1, wherein the spacing is at least 5 millimeters.

4. The computing device of claim 1, further comprising:
a polarizer that allows light of a specific polarization while blocking light of other polarizations.

5. The computing device of claim 4, wherein the specific polarization corresponds to scattered light reflected by an object toward which the first and second illuminants sequentially emit light.

6. The computing device of claim 1, wherein the plurality of illuminants includes at least one illuminant that is able to emit ultraviolet light or infrared light.

7. The computing device of claim 1, wherein each illuminant of the plurality of illuminants included in the light source has a filter installed thereon to reduce spectral overlap on subpixels corresponding to different colors.

8. A method for estimating a range to a target, the method comprising:
activating a first light source that includes
(i) a first illuminant having a first spectral emission profile, and
(ii) a second illuminant having a second spectral emission profile different than the first spectral emission profile;
receiving, from an image sensor, a first image of the target illuminated by the first and second illuminants of the first light source;
determining, for the first image, first intensities for (i) a first set of subpixels of the image sensor and (ii) a second set of subpixels of the image sensor;
activating the first illuminant of the first light source, so as to illuminate the target with light having the first spectral emission profile;
activating a second light source that is spaced apart from the first light source,
wherein the second light source includes a third illuminant having the second spectral emission profile;
receiving, from the image sensor, a second image of the target illuminated by the first illuminant of the first light source and the third illuminant of the second light source;
determining, for the second image, second intensities for (i) the first set of subpixels of the image sensor and (ii) the second set of subpixels of the image sensor;
establishing a difference between the first and second intensities; and
estimating the range to the target based on the difference between the first and second intensities.

9. The method of claim 8,
wherein the first set of subpixels of the image sensor is associated with the first spectral emission profile, and
wherein the second set of subpixels of the image sensor is associated with the second spectral emission profile.

10. The method of claim 8, wherein the third illuminant is the sole illuminant of the second light source.

11. The method of claim 8, further comprising:
activating the second illuminant of the first light source, so as to illuminate the target with light having the second spectral emission profile;
activating a third light source that is spaced apart from the first and second light sources,
wherein the third light source includes a fourth illuminant having the first spectral emission profile;
receiving, from the image sensor, a third image of the target illuminated by the second illuminant of the first light source and the fourth illuminant of the third light source;
determining, for the third image, third intensities for (i) the first set of subpixels of the image sensor and (ii) the second set of subpixels of the image sensor; and
establishing a difference between the first and third intensities.

12. The method of claim 11, wherein said estimating is further based on the difference between the first and third intensities.

13. The method of claim 11, further comprising:
discovering that the second light source is more useful than the third light source for estimating the range based on an analysis of the difference between the first and second intensities and the difference between the first and third intensities;
wherein said estimating is performed in response to said discovering.

14. A method for determining depth of a target through illumination parallax by a display panel of a computing device, the method comprising:
operating a plurality of regions of the display panel having spatial separation, so as to provide illumination parallax of the target,
wherein the plurality of regions have orthogonal modulation in the time domain, frequency domain, or code domain;
receiving a temporal series of images captured in conjunction with the illumination parallax of the target; and
processing the temporal series of images to obtain a differential response due to the illumination parallax of the target.

15. The method of claim 14, further comprising:
producing, based on the differential response, information that indicates depth at various regions included in the temporal series of images.

16. The method of claim 14, wherein the plurality of regions extend along opposing sides of the display panel.

17. The method of claim 14, wherein the plurality of regions correspond to opposing corners of the display panel.

18. The method of claim 14, wherein modulation of the plurality of regions is incommensurate with a rate at which the images included in the temporal series are output by an image sensor.

19. The method of claim 14, wherein each region of the plurality of regions is modulated at a different frequency.

20. The method of claim 14,
wherein the plurality of regions extend along a first set of opposing sides of the display panel in a first direction,
wherein the method further comprises:
operating a second plurality of regions of the display panel having spatial separation, so as to provide another illumination parallax of the target,
wherein the second plurality of regions extend along a second set of opposing sides of the display panel in a second direction.

21. The method of claim 20, wherein operating the second plurality of regions enabled differentials along different directions to be obtained.
